(19) United States
(12) Patent Application Publication
(10) Pub. No.: US 2025/0158524 A1
(43) Pub. Date: May 15, 2025

(54) FREQUENCY CONTROLLED MULTIPHASE CURRENT SOURCE SYSTEM

(71) Applicant: SEMICONDUCTOR COMPONENTS INDUSTRIES, LLC, Scottsdale, AZ (US)

(72) Inventor: Basil ALMUKHTAR, Dooradoyle (IE)

(73) Assignee: SEMICONDUCTOR COMPONENTS INDUSTRIES, LLC, Scottsdale, AZ (US)

(21) Appl. No.: 18/505,354

(22) Filed: Nov. 9, 2023

(51) Int. Cl. H02M 3/158; H02M 1/084

(52) U.S. Cl. CPC H02M 3/158; H02M 1/084

(57) ABSTRACT

A voltage regulator is described for use in high power delivery applications, including notebook computers, ultra-book computers, and electric vehicles. The voltage regulator is configured with multiphase current and constant on-time (COT) control. The voltage regulator can be configured with adaptive on-time control with zero undershoot in the output voltage signal, in response to a dynamic load. The multiphase current source can be configured with adjustable current share gain to provide a democratic current balance method. A method of operating the voltage regulator can be compatible with analog, digital, and hybrid implementations.

### TECHNICAL FIELD

This description relates to a voltage regulator circuit in a power delivery system for industrial and automotive core applications. More specifically, this description relates to a voltage regulator circuit that includes a multiphase current source system with constant on-time control.

### BACKGROUND

Power converters can be used, for example, in automotive systems to convert a high voltage, e.g., 400 V supplied by an electric vehicle (EV) battery, to a lower voltage (e.g., 12 V or 5 V) for use in powering auxiliary devices such as sensors, dashboard electronics, multimedia systems, power windows, LED lighting, and so forth. Known power converters may not have features that are well-suited for some applications.

### SUMMARY

In some aspects, the techniques described herein relate to a circuit, including: a multiphase current source, including: a first current loop configured to drive a first inductor with a first drive signal at a first switching frequency; a second current loop configured to drive a second inductor with a second drive signal at a second switching frequency; and a voltage loop including a constant on-time (COT) control stage configured to provide a control signal with a leading edge modulation based on voltage error and a trailing edge modulation based on current share error.

In some aspects, the techniques described herein relate to a circuit, wherein pulse width modulation (PWM) drive signals are out of phase with one another in a multiphase application.

In some aspects, the techniques described herein relate to a circuit, configured as a buck voltage regulator circuit in which an output voltage is less than an input voltage.

In some aspects, the techniques described herein relate to a circuit, wherein the input voltage is in a range of about 5 V to about 21 V and the output voltage is in a range of about 0.2 V to about 3.3 V.

In some aspects, the techniques described herein relate to a circuit, configured as a boost voltage regulator circuit in which an output voltage is greater than an input voltage.

In some aspects, the techniques described herein relate to a circuit, wherein an output voltage signal is configured to achieve zero undershoot response in a droop system when the multiphase current source is coupled to a dynamic load.

In some aspects, the techniques described herein relate to a circuit, wherein the multiphase current source further includes a masterless current share loop configured to provide a trailing edge current error correction.

In some aspects, the techniques described herein relate to a circuit, wherein the COT control stage includes an integrator.

In some aspects, the techniques described herein relate to a circuit, wherein the COT control stage includes a trigger ramp.

In some aspects, the techniques described herein relate to a circuit, wherein the COT control stage is configured to provide control pulses that are out of phase with one another.

In some aspects, the techniques described herein relate to a circuit, wherein a current share loop gain of the circuit is dynamically adjustable based on an error signal level.

In some aspects, the techniques described herein relate to a circuit, wherein a current share loop gain of the circuit is part of a Ton ramp.

In some aspects, the techniques described herein relate to a circuit, wherein a current share loop gain of the circuit is adjustable by changing a height of the Ton ramp.

In some aspects, the techniques described herein relate to a circuit, wherein a footprint of the circuit is less than about 25 mm2.

In some aspects, the techniques described herein relate to a method of regulating a voltage, the method including: performing a DC-to-DC voltage conversion in a circuit coupled to a dynamic load; providing an output current from a multiphase current source; varying a pulse frequency in response to a change in a load current; varying a pulse width in response to the change in the load current, to provide adaptive on-time control; increasing the output current to match the load current at a high speed; and delivering an output voltage signal having zero undershoot.

In some aspects, the techniques described herein relate to a method, wherein the response to the change in the load current includes supplying the output current in increasing steps.

In some aspects, the techniques described herein relate to a method, wherein providing the output current includes use of a masterless current balance procedure.

In some aspects, the techniques described herein relate to a method, wherein the method is compatible with analog, digital, and hybrid implementations.

In some aspects, the techniques described herein relate to a system, including: a power delivery circuit configured to deliver power to a dynamic load, the power delivery circuit including: a voltage regulator having an input voltage, an output voltage, and an output capacitance; and a constant on-time (COT) control stage configured to provide variable on-time in response to a change in the dynamic load.

In some aspects, the techniques described herein relate to a system wherein the voltage regulator is configured to provide a stable output voltage signal with zero undershoot.

In some aspects, the techniques described herein relate to a system, wherein the output voltage signal remains stable when the output capacitance is less than 1 mF.

In some aspects, the techniques described herein relate to a system, further including a multiphase current source system configured with adjustable current share gain.

### BRIEF DESCRIPTION OF THE DRAWINGS

FIGS. 1 and 2 are high-level circuit schematic diagrams depicting buck converter circuits, according to implementations of the present disclosure.

FIG. 3 is a timing diagram illustrating a response of the buck converter circuit shown in FIG. 2 to a step-up in a dynamic load current, according to implementations of the present disclosure.

FIG. 4 is a detailed circuit schematic diagram of a buck converter circuit, featuring variable frequency leading edge constant on-time (COT) control, according to implementations of the present disclosure.

FIG. 5 is a timing diagram illustrating a response of the buck converter circuit shown in FIG. 4 to a step-up in a dynamic load current, according to implementations of the present disclosure.

FIG. 6 is a detailed circuit schematic diagram of a buck converter circuit, including variable frequency dual edge COT control, according to implementations of the present disclosure.

FIG. 7 is a timing diagram showing a response of the buck converter circuit shown in FIG. 6 to a step-up in a dynamic load current, according to implementations of the present disclosure.

FIG. 8 is a detailed circuit schematic diagram depicting a multiphase buck converter circuit with variable on-time COT control and current balance, according to implementations of the present disclosure.

FIG. 9 is a circuit schematic diagram of a current share loop, according to implementations of the present disclosure.

FIG. 10 is a high-level system block diagram of a frequency modulated constant current system, with COT control modulated to current share error, according to implementations of the present disclosure.

FIG. 11 is a two-phase timing diagram corresponding to the multiphase buck converter circuit, shown in FIG. 8, according to implementations of the present disclosure.

FIG. 12 is a timing diagram illustrating a current share error correction response of the multiphase buck converter circuit shown in FIG. 8, according to implementations of the present disclosure.

FIG. 13 is a flow diagram illustrating a method of operating a buck converter circuit, according to implementations of the present disclosure.

FIGS. 14A, 14B, 15A, and 15B are a series of plots of simulation results showing features of a buck converter circuit, according to implementations of the present disclosure.

Aspects of the present disclosure are best understood from the following detailed description when read with the accompanying figures. It is noted that various features are not necessarily drawn to scale. Dimensions of the various features may be arbitrarily increased or reduced for clarity of discussion. In the drawings, like reference symbols may indicate like and/or similar components (elements, structures, etc.) in different views. The drawings illustrate generally, by way of example, but not by way of limitation, various implementations discussed in the present disclosure. Reference symbols shown in one drawing may not be repeated for the same, and/or similar elements in related views. Reference symbols that are repeated in multiple drawings may not be specifically discussed with respect to each of those drawings but are provided for context between related views. Also, not all like elements in the drawings are specifically referenced with a reference symbol when multiple instances of an element are illustrated.

### DETAILED DESCRIPTION

At least some of the power converter implementations that are described herein are configured to address a variety of problems with known power converters. For example, the power converters described herein can be configured to address, using current balancing, hot spot issues that can arise at certain currents and voltages in some applications. For example, in a high-power delivery circuit suitable for use in electric vehicles (EVs) or industrial applications, as the output voltage is reduced by a power converter (e.g., a DC-DC power converter), the output current is increased. This can result in relatively large currents being present (e.g., on the order of about 30 Amps per phase to about 40 Amps per phase), which can create hot spots in some circuits. The implementations herein can avoid hot spots by maintaining a current balance throughout the circuit. In addition, the voltage regulator of the high-power delivery circuit may be used to maintain a stable output voltage, e.g., an output voltage within a tight range, for example, with variation less than about +/−10%.

At least some of the power converter implementations described herein can also be used to fulfill tightly regulated load power delivery demand of high-performance microprocessor systems. For example, the power converter implementations herein can be configured to support the high load demand of high-performance central processing units with low power budget and/or reduced (e.g., minimal) cost compact solutions. To support high slew rate loads, multiphase operation can be used in some implementations, with all phases synchronized for fast turn-on, to maximize load speed with minimal undershoot output voltage dynamic response. The power converters described herein can include design considerations for fast dynamic response, reduced (e.g., minimal) output voltage disturbance, tight current balance, and/or the stability of the voltage regulator at minimum output capacitance.

At least some of the power converters described herein implement constant on-time control (COT), which is used in voltage regulator module (VRM) applications for high bandwidth capability and inherent frequency scaling in light load applications. In contrast to the power converters described herein, some known systems with COT and minimum off time have the drawback of large dynamic undershoot and overshoot caused by limited inductor current increments and load release timing relative to Tₒₙ cycle. To overcome this limitation, variable on time and off time control can be introduced through Tₒₙ adaptive nonlinear extension circuits. These circuits, however, can add complexity with stringent timing requirements.

Also, at least some of the power converters described herein can be used in multiphase applications. In some known systems, current balance can be achieved by control systems with a reference current for all phases to track as current mode control, or by a dedicated parallel current share loop. These methods add complex compensation networks, cause voltage undershoot response and can be slow to respond to fast dynamic loads with bandwidth limits against other loops in parallel. Multiphase COT control methods can lack a simple high speed current balance method to maintain tight current balance during dynamic loading without added power, complexity, and cost.

At least some of the power converter implementations described herein have the advantages describe above, but also address the limitations described above in known systems, with a simple low cost adaptive COT control method. The methods described herein extend single edge COT control to a dual edge adaptive COT control, with masterless current balance. These techniques result, in some implementations, in a zero voltage undershoot response at minimal output load capacitance, a compensation network with reduced (e.g., minimal) complexity, and/or a fast current balance technique with a built-in dynamic gain adjustment.

There are at least three types of power converters that can implement the solutions described above—a buck converter, a boost converter, and a buck-boost converter. The figures that are shown and described herein are specifically directed to a buck converter implementation, by way of example only. Any of the implementations described herein related to the buck converter can also be included in any type of power converter such as a boost converter or a buck-boost converter. A buck converter is a DC-DC power converter in which the output voltage is less than the input voltage. A buck converter can also be referred to as a step-down converter. A boost converter is a DC-DC power converter in which the output voltage is greater than the input voltage. A boost converter can also be referred to as a step-up converter. A DC-DC power converter can also be referred to as a voltage regulator, and one type of DC-DC power converter can be a switching regulator, which regulates power by operating transistors as switches, with high efficiency. In industrial applications, power converters can be used to convert a high voltage to a lower voltage for use by microprocessor-based systems, e.g., mobile computing devices such as notebook computers or tablets.

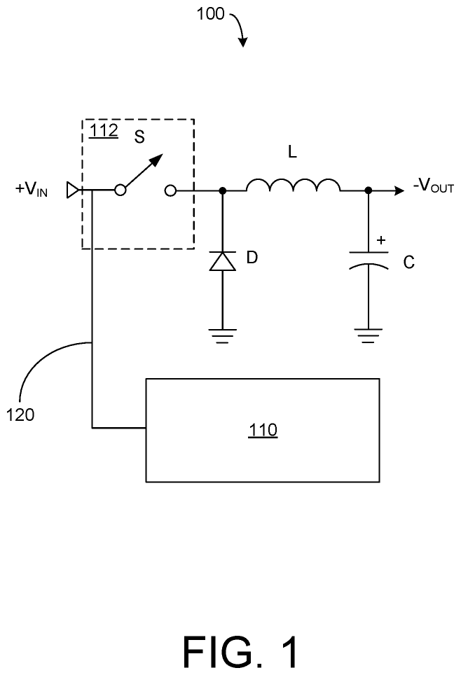

FIG. 1 is a high level schematic circuit diagram of a voltage regulator, according to some implementations of the present disclosure. Specifically, FIG. 1 illustrates a step-down buck converter circuit 100, according to some implementations of the present disclosure. The buck converter circuit 100 is a switching voltage regulator circuit in which Vᵢₙ exceeds Vₒᵤₜ, In some automotive or industrial implementations, Vᵢₙ can be in a range of about 100 V to about 500 V and Vₒᵤₜ can be in a range of about 5 V to about 15 V. In some computing implementations, Vᵢₙ can be in a range of about 5 V to about 21 V and Vₒᵤₜ can be in a range of about 0.2 V to about 3.3 V. The buck converter circuit 100 includes a power switch S, an inductor L, and a diode D as fundamental elements to transfer energy from the input to the output. The power switch S can be considered a drive stage 112, which can be implemented as, for example, one or more metal-oxide-semiconductor field effect transistors (MOSFETs). When the power switch S closes, energy is stored in the inductor L. When the power switch S opens, energy is discharged from the inductor L through a dynamic load represented by a variable load capacitor Cout. Thus, the inductor current is controlled by how frequently the MOSFETs are activated, and the on-time during which the switch S is closed. In some implementations, the switch S can be operated according to a control stage 110 that supplies a control signal 120, e.g., a timing signal or clock signal, to the switch S.

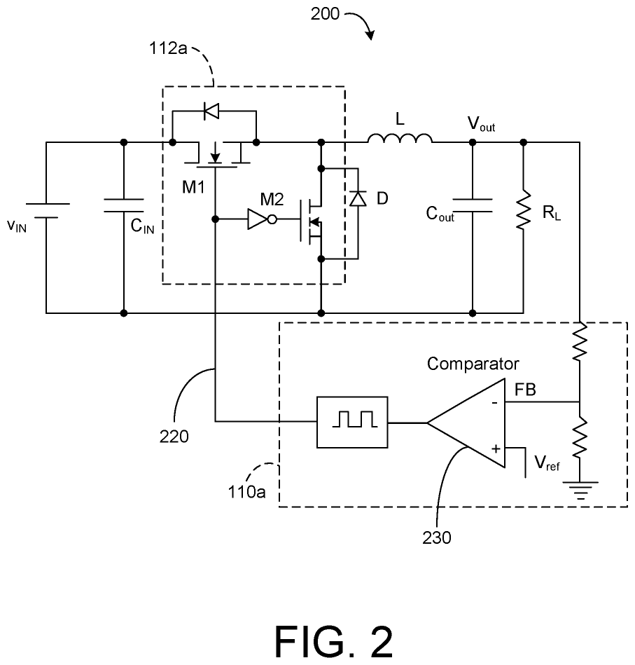

Details of the control stage 110, presented in FIG. 1, are shown and described below with different details and/or complexity in the various figures. For example, more detailed versions of the control stage 110 are illustrated in FIGS. 2, 4, 6, and 8 as control stages 110a, 110b, 110c, and 110d, respectively. Likewise, details of the drive stage 112 presented in FIG. 1 are shown and described below with different details and/or complexity in the various figures. For example, more detailed versions of the drive stage 112 are illustrated in FIGS. 2, 4, 6, and 8 as drive stages 112a, 112b, 112c, and 112d, respectively.

FIG. 2 is a high level schematic circuit diagram of a voltage regulator, according to some implementations of the present disclosure. Specifically, FIG. 2 illustrates an example buck converter circuit 200 that includes some of the elements of the voltage regulator shown in FIG. 1, according to some implementations of the present disclosure. The example buck converter circuit 200 is implemented with the control stage 110a, the diode D, the inductor L and the load capacitor Cout. The power switch S is implemented as a drive stage 112a. As shown in FIG. 2, the drive stage 112a includes a first MOSFET M1 and a second MOSFET M2. The MOSFETs of the power switch S are both operated, e.g., driven, by a pulsed control signal 220, generated in the control stage 110a. The pulsed control signal 220 is implemented as a pulse signal output of a pulse generator 230, so as to reduce the input voltage to a lower output voltage.

Various control topologies can be used to generate the pulsed drive control signal 220, including voltage-mode control, current-mode control, and/or constant on-time (COT) control. The example control stage 110a as shown in FIG. 2 is a high-level illustration of COT control, in which the pulsed drive control signal 220 takes the place of a fixed frequency clock. The COT pulse generator can be triggered to generate pulses with variable frequency depending on the load. In some implementations, the COT pulse generator can be triggered to generate pulses having variable width, that is, with variable on-time and off-time, depending on the load.

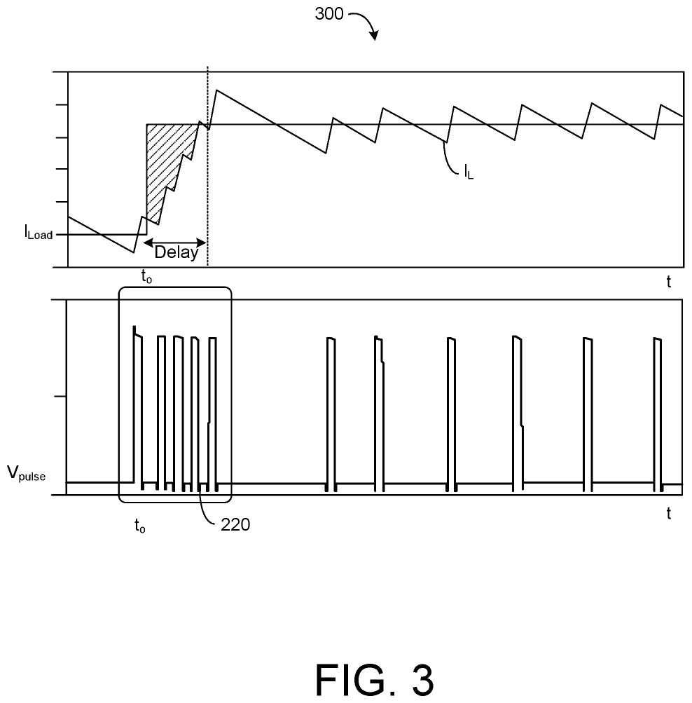

FIG. 3 is a timing diagram illustrating a COT control scheme 300, according to some implementations of the present disclosure. The COT control scheme 300 can be applied to the control stage 110a of the buck converter circuit 200 shown in FIG. 2 to produce the pulsed drive control signal 220. In some implementations, a COT control scheme 300 can be applied to a control stage of a boost converter circuit. The timing diagram shows the pulse signal 220 and the inductor current I_{L} through the inductor L as a function of time, in response to a dynamic load current I_{load} through the load capacitor Cout (shown in at least FIG. 2).

FIG. 3 illustrates at least one of the important benefits of COT control. As shown in FIG. 3, in the COT control scheme 300, when the load current I_{load} suddenly increases at time to, the frequency of the pulsed drive control signal 220 can temporarily increase to meet the demand for higher output current delivered to the inductor. Consequently, the delay time between to and the time at which the inductor current I_{L} rises to the high value of I_{load} (indicated by the dotted line in FIG. 3) is much shorter than it would otherwise be using a constant pulse frequency. The control stage 110a can be configured so that the output current rises in increasing steps to match the load current within a prescribed, or predetermined, time delay.

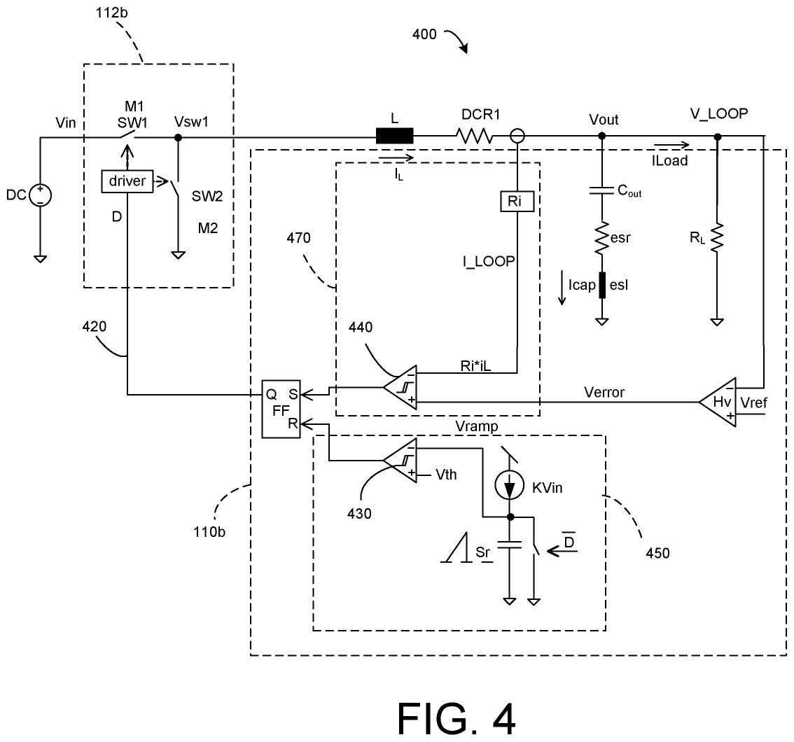

FIG. 4 is a high-level schematic circuit diagram of an example buck converter circuit 400, according to some implementations of the present disclosure. The buck converter circuit 400 is a variation of the voltage regulator implementation shown in FIG. 1. The buck converter circuit 400 is implemented with the control stage 110b, the drive stage 112b, the inductor L, the dynamic load capacitor Cout and a drive control signal 420. In the example buck converter circuit 400, the drive control signal 420 to the drive stage 112b is a leading single edge modulated COT pulse. Single edge COT control uses at least one inner current control loop I_LOOP and one outer voltage loop V_LOOP. In the example implementation shown in FIG. 4, the control stage 110b includes a leading edge control stage 470 and a COT control stage 450. The leading edge control stage 470 is configured with a leading edge comparator 440 having as inputs an inductor current signal Ri*I_{L} (I1_Loop) and a regulated voltage error signal Vₑᵣᵣₒᵣ. The COT control stage 450 includes is configured with a Tₒₙ comparator 430 having as inputs a COT ramp signal Vᵣₐₘₚ, and a fixed threshold voltage, Vₜₕ.

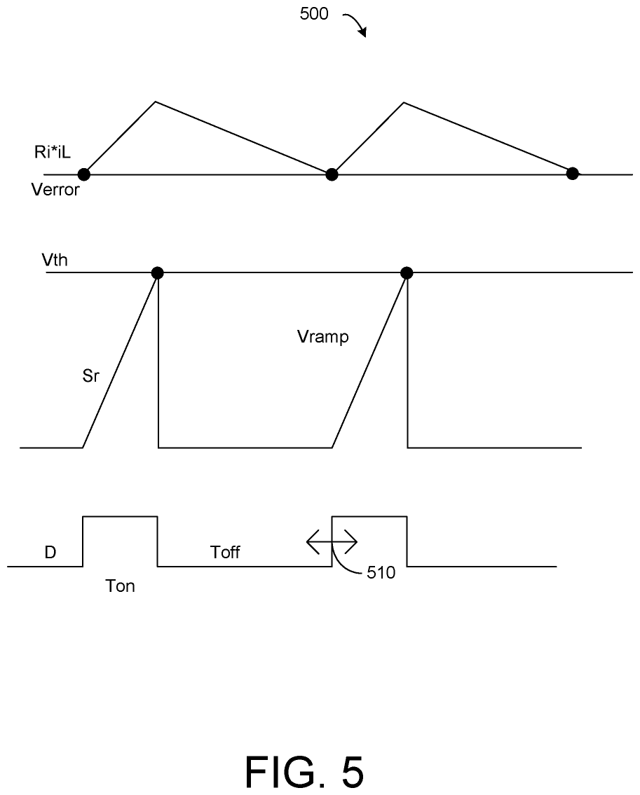

FIG. 5 is a timing diagram illustrating a single edge modulated COT control scheme 500, according to some implementations of the present disclosure. The COT control scheme 500 can be applied to the COT control stage 110b of the buck converter circuit 400 shown in FIG. 4, to produce the drive control signal 420 from COT pulse output signals of the leading edge comparator 440 and the Tₒₙ comparator 430. COT pulses have variable frequency leading edge modulation 510 generated by an inductor current signal I_{L}, compared against a regulated error signal Vₑᵣᵣₒᵣ. The COT pulse output signal from the Tₒₙ comparator 430 is generated at least by the voltage ramp signal Vᵣₐₘₚ compared against a fixed threshold voltage Vₜₕ.

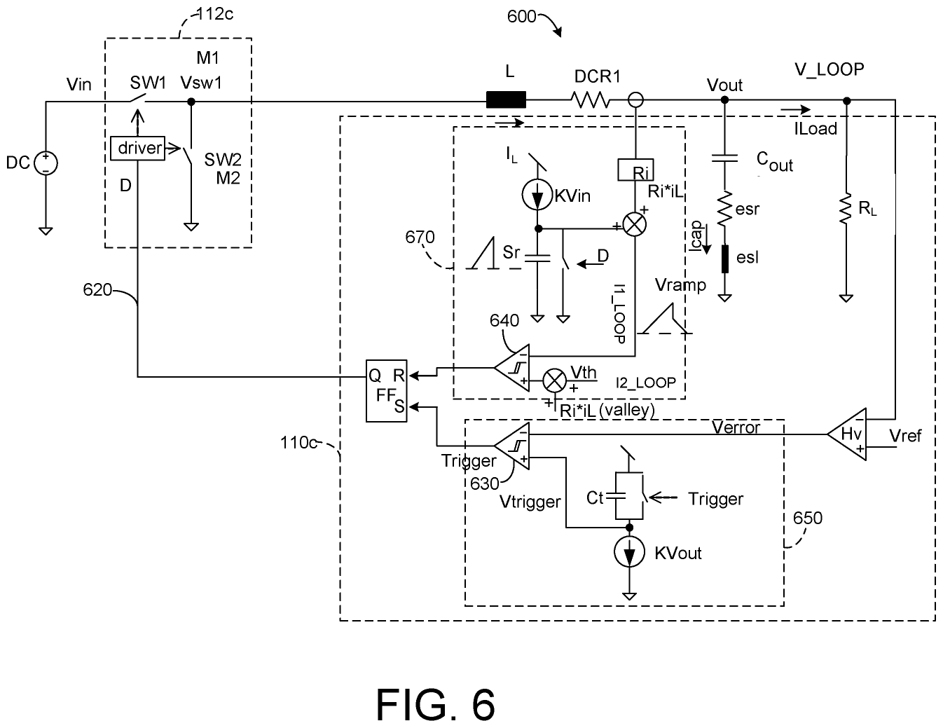

FIG. 6 is a detailed schematic circuit diagram of an example buck converter circuit 600, according to some implementations of the present disclosure. The buck converter circuit 600 is a variation of the voltage regulator implementation shown in FIG. 1. The buck converter circuit 600 is implemented with the control stage 110c, the drive stage 112c, the inductor L, the load capacitance Cout and a drive control signal 620. In the example buck converter circuit 600, the drive control signal 620 to the drive stage 112c is a dual edge modulated COT pulse. Dual edge COT control uses two inner current loops, I1_LOOP and I2_LOOP, and one outer voltage loop V_LOOP. In the example implementation shown in FIG. 6, the control stage 110c includes a leading edge control stage 650 and a trailing edge control stage 670. The leading edge control stage 650 is configured with a leading edge comparator 630 having as inputs a trigger ramp signal V_{trigger} and a regulated error signal Vₑᵣᵣₒᵣ generated by error amp HV.

In some implementations, the trigger ramp signal V_{trigger} can be a single ended or a differential trigger ramp signal. The trigger ramp signal V_{trigger} can be an analog generated signal or a digital signal, e.g., a signal that uses a digital counter approach. In some implementations, trailing edge control stage 670 can be configured with a trailing edge comparator 640 having as inputs a voltage ramp Vᵣₐₘₚ and a threshold voltage Vₜₕ summed with valley inductor current information (I2_Loop). In some implementations, Vᵣₐₘₚ is generated by summing inductor current information (I1_Loop) during off time with the COT ramp signal Sr.

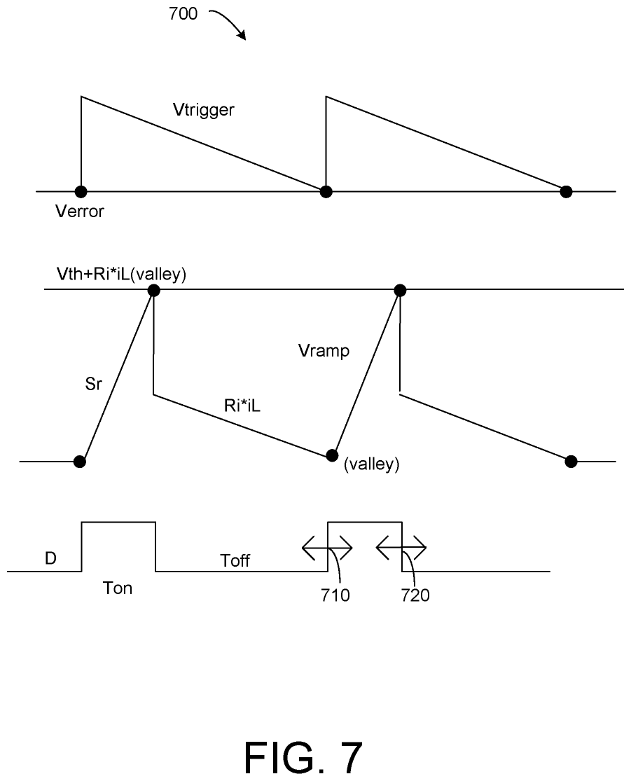

FIG. 7 is a timing diagram illustrating a dual edge modulated COT control scheme 700, according to some implementations of the present disclosure. The dual edge modulated COT control scheme 700 can be applied to the control stage 110c of the buck converter circuit 600 to produce the COT drive control signal 620 in a single phase configuration. Generated COT pulses are variable frequency pulses having dual edge modulation, e.g., a leading edge modulation 710 and a trailing edge modulation 720. The leading edge modulation 710 is generated by comparing the trigger ramp signal V_{trigger} to the regulated voltage error signal Vₑᵣᵣₒᵣ, in the leading edge comparator 630. In some implementations, the trailing edge modulation 720 is based on current share error. For example, the trailing edge modulation 720 can be generated by comparing the voltage ramp signal Vᵣₐₘₚ against the Tₒₙ threshold voltage signal Vₜₕ summed with valley current information RiI_{L} in the trailing edge comparator 640. The dual edge modulated COT control scheme 700 can have variable on time (trailing edge for valley current error correction) and/or variable off time (leading edge for voltage error correction).

In some implementations, a corresponding temporary sag in the output voltage V_{OUT} may accompany the rise in the inductor current signal I_{L}. Thus, controlling the frequency of the pulsed drive control signal 620 also controls the output voltage. In some existing control systems, the sagging output voltage can also exhibit undershoot. Proper control of the pulsed drive control signal 620 can potentially reduce or eliminate the voltage undershoot. COT control therefore has the advantages of being able to maintain stability and high bandwidth capability, along with inherent frequency scaling in light load applications.

As mentioned above, some drawbacks of COT control include large dynamic undershoot and overshoot in the output current caused by limited inductor current increments and load release timing relative to the Tₒₙ cycle. These aspects are illustrated by the jagged plot of the inductor current I_{L} in the upper frame of FIG. 3. Existing solutions to these drawbacks have introduced variable on-time and off-time control using on-time adaptive nonlinear extension circuits. However, such circuits add complexity with stringent timing requirements.

Accordingly, the disclosure of FIGS. 6 and 7 are related to a scalable control method to extend COT on-time during dynamic loading. In addition to variable frequency, the enhanced COT, according to FIGS. 6 and 7, provides for a modulated on-time instead of a fixed on-time, with a new built-in fast response current balance method.

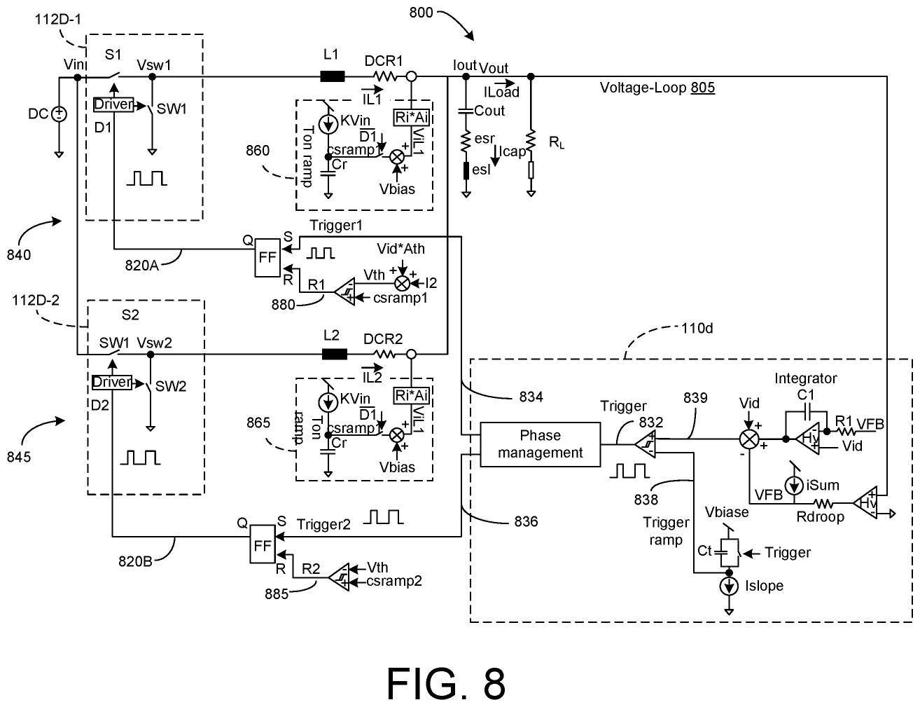

FIG. 8 is a detailed schematic circuit diagram of an example buck converter circuit 800, according to some implementations of the present disclosure. The buck converter circuit 800 is a variation of the voltage regulator implementation shown in FIG. 1. The buck converter circuit 800 includes a first drive stage 112d-1 with a drive switch S1 and a second drive stage 112d-2 with a drive switch S2 for energizing and discharging two inductors L1 and L2, respectively, through the load capacitance Cout and the resistive load R_{L}. The buck converter circuit 800 is further implemented with the control stage 110d that features multiphase design and dual edge COT control. The multiphase current source provides an output current Iₒᵤₜ having a first current component IL1 and a second current component IL2 that are out of phase with one another. The buck converter circuit 800 offers a compact footprint solution. In some implementations, the area of the footprint can be less than about 5 mm×5 mm, or 25 mm².

The structure of the buck converter circuit 800 includes a voltage loop 805 a first current loop 840, and a second current loop 845 that define a frequency-modulated multiphase current source system to provide current balance as described below. The first current loop 840 regulates the first current component IL1 by driving the first inductor L1 with a first drive signal 820A at a first switching frequency. The second current loop 845 regulates the second current component IL2 by driving the second inductor L2 with a second drive signal 820B at a second switching frequency. Switching frequencies may range from about 20 kHz in a discontinuous conduction mode to about 2 MHz in a continuous conduction mode. In some implementations, the second drive signal 820B is out of phase with the first drive signal 820A.

The voltage loop 805 of the buck converter circuit 800 is implemented with a leading edge COT control stage 810. The leading edge COT control stage 810 generates a pulse control signal, or trigger pulse 832. The trigger pulse 832 is split into a first trigger pulse 834 and a second trigger pulse 836 that are 180 degrees out of phase. The first trigger pulse 834 activates the drive switch S1 with COT pulse D1 of drive signal 820A, to operate the first inductor L1. In parallel, the second trigger pulse 836 activates a driver S2 with COT pulse D2 of the drive signal 820B, to operate the second inductor L2. The multiphase currents, e.g., the first current component IL1 and the second current component IL2, sum to Iₒᵤₜ.

The trigger pulse 832 can be generated in the COT control stage 110d (shown in FIG. 8) by comparing a trigger ramp signal 838 with a voltage error signal 839. The trigger pulse 832 is phase managed to the first trigger pulse 834 and the second trigger pulse 836 to generate a rising COT pulse D1 of the drive signal 820A and a rising COT pulse D2 the drive signal 820B in leading edge modulation.

Reset ramp signals 880 and 885 determine falling COT pulses D1 and D2 in trailing edge modulation. In some implementations, the voltage error signal 859 includes iSum information 920 for a constant output impedance droop response. In some implementations, the voltage error signal 859 also includes an integrator that cancels the output offset generated by the trigger ramp signal 838. The integrator can be an amplifier analog block or digital filter approach.

Additionally, in some implementations, the first current component IL1 can be added to a first Tₒₙ ramp cs_ramp1 by a first current loop 860 while the second current component IL2 (e.g., second current of phase 2) is added to a second Tₒₙ ramp cs_ramp2 by a second current loop 865. In some implementations, at least one of the current loops 860 and 865 is configured as a masterless current share loop that provides a trailing edge current error correction. The current loops 860 and 865 can be used to tune the currents, thereby balancing current values so that hot spots (e.g., circuit hot spots as described above) can be avoided. In some implementations, the current loops 860 and 865 can be used to tune phase current error against an average current reference 12, thereby balancing current using a masterless approach.

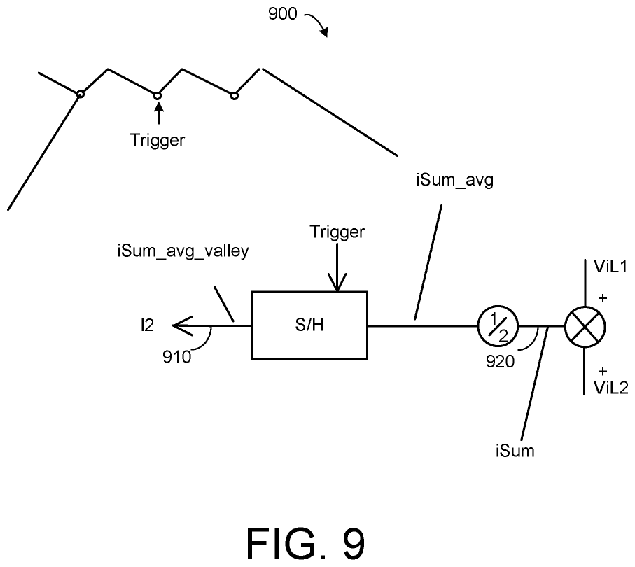

FIG. 9 is a schematic circuit diagram 900 showing generation of the average valley 12 at 910 as a current share reference, according to some implementations of the present disclosure. Average valley 12 is shown in FIG. 8 as an input used to generate the reset ramp signal 880 in the first current loop 840. Currents IL1 and IL2 are summed at 920. The average (1/2) of the resultant current is then provided as a current share reference, where valleys in the resultant current signal are trigger points.

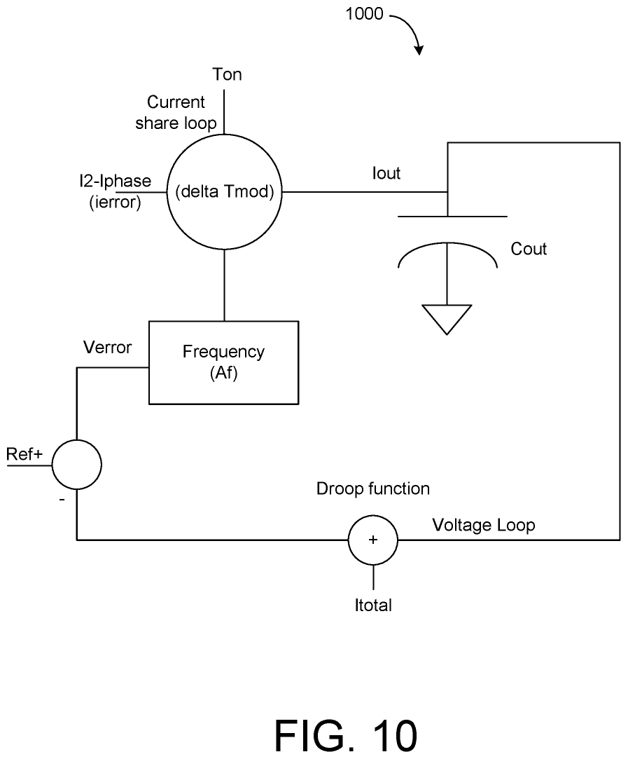

FIG. 10 is a simplified schematic circuit diagram of a frequency controlled multiphase current source system 1000, according to some implementations of the present disclosure. The frequency controlled multiphase current source system 1000 corresponds to the single phase buck converter circuit 600 shown in FIG. 6, and the multiphase buck converter circuit 800 shown in FIG. 8. In the frequency controlled multiphase current source system 1000, a loop frequency Af modulates with voltage error. In the frequency controlled multiphase current source system 1000, Tₒₙ modulates with current balance error. Thus, Tₒₙ is based on an error signal level. Also, in the frequency controlled multiphase current source system 1000, phase currents track a system reference current I2.

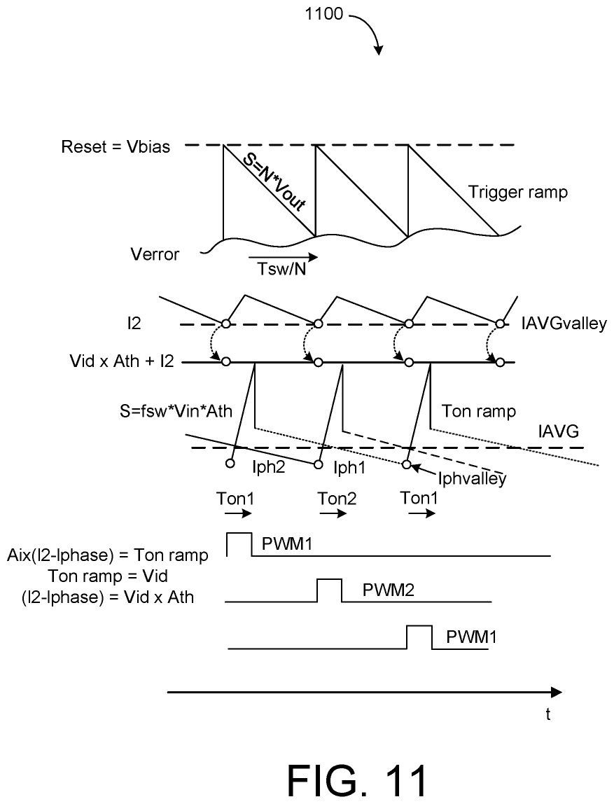

FIG. 11 is a timing diagram illustrating an enhanced COT control scheme 1100 for the buck converter circuit 800 (shown in FIG. 8), according to some implementations of the present disclosure. FIG. 11 shows multiphase COT control in a two-phase application. Modulation at the leading edge of each pulse (Tₒₙ) is provided by a trigger ramp inception with voltage error. In some implementations, the trigger ramp has a slope S=N*Vₒᵤₜ, wherein N is the number of phases and Vₒᵤₜ is a regulated output voltage. In some implementations, a fixed on time pulse width modulation (PWM) trailing edge is generated by a Tₒₙ ramp with slope s=fsw*Vᵢₙ*Aₜₕ, where fsw is a switching frequency, Vᵢₙ is an input supply voltage, and Aₜₕ is a scaling element. In some implementations, inception against a threshold that includes valley average current information (I2) for all phases in parallel, where a switching period T_{sw} is given by 1/fsw, the inverse of the switching frequency fsw, and Aₜₕ is given by 1/Aᵢ (the inverse of the current share loop gain). The Aₜₕ parameter is a Tₒₙ ramp height and slope scaling element used to adjust the current share loop gain (Aᵢ), without impacting loop operating frequency. The on-time ramp, Tₒₙ ramp=V_{id}*Aₜₕ+I2-I phase, where Via is a target reference voltage and Iₚₕₐₛₑ is per phase current. In some implementations, current share decision making can be based on per phase current valley and average valley current share reference information. In some implementations, this method offers high bandwidth and better noise rejection while maintaining loop response speed without adding low pass filters,

FIG. 11 shows that the multiphase current source system of FIG. 8 is configured with an adjustable current share gain. With dual edge modulation, Tₒₙ is adaptive, overcoming the fixed on-time limitation of existing COT control schemes. With this method, Tₒₙ includes current, Vᵢₙ, and Vₒᵤₜ feed-forward information. In some implementations, the adjustable current share gain is a simple current share gain tuning method that provides a dynamically adjustable gain of the masterless current share loop by changing a height of the Tₒₙ ramp without adding complexity or extra resources into the COT system.

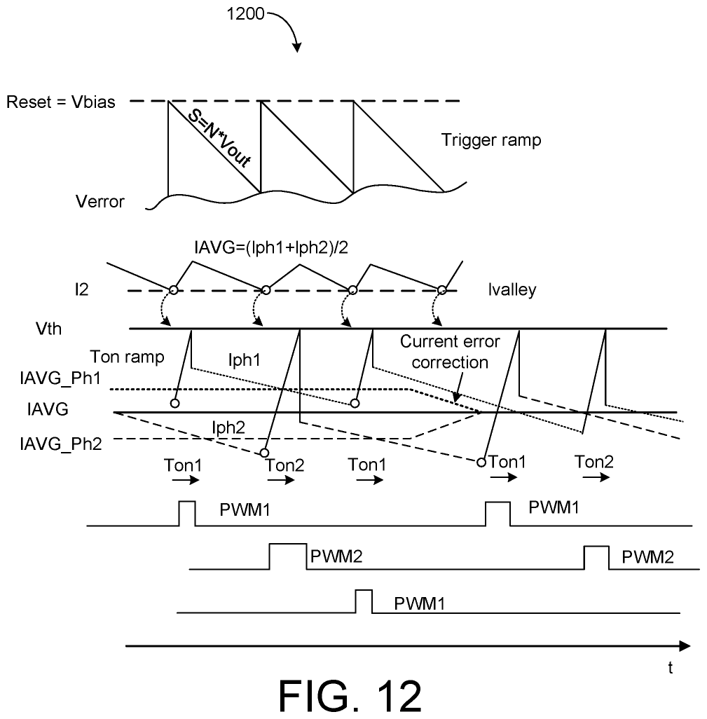

FIG. 12 is a timing diagram illustrating an enhanced COT control scheme 1200 for the buck converter circuit 800 (shown in FIG. 8) under a current balance error correction, according to some implementations of the present disclosure. The current balance error can be caused by a mismatch in impedance path across parallel phases. In some implementations, the Tₒₙ value per phase modulates with the phase current error. In some implementations, I2 current feed-forward provides a valley reference current I2_{ref} for each of the parallel phase currents. The average current is given by I_{avg}=(Iₚₕ₁+Iₚₕ₂)/2. A current error correction can be made such that Iₚₕ₁ has a smaller Tₒₙ with a larger phase current and Iₚₕ₂ has a larger Tₒₙ with a smaller phase current. The highest current gain occurs when Iₚₕₐₛₑ is close to I2_{ref}, rapidly bringing the system back to the nominal operating point, while the I_{Ph} farther away from I2 reference has the least gain in the system. This dynamic gain adjustment provides extra stability and damping to phase current share response while rapidly converging to a current reference I2 avoiding overshoot and ringing in the system response.

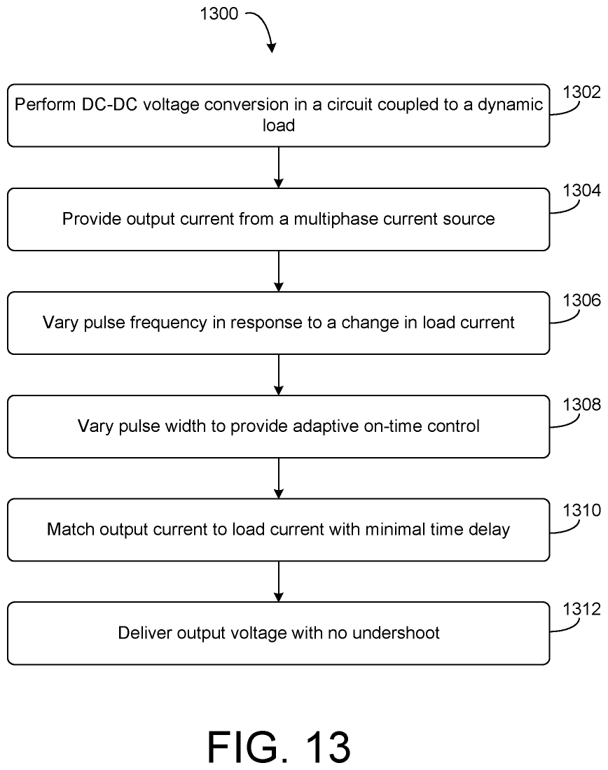

FIG. 13 is a flow chart illustrating a method 1300 for operating a DC-to-DC converter, or voltage regulator, e.g., the buck converter circuit 800 (shown in at least FIG. 8), in accordance with some implementations of the present disclosure. Operations 1302-1312 of the method 1300 can be carried out to step down a high input voltage to a low output voltage, according to some implementations as described above with reference to FIGS. 1-12. Operations of the method 1300 can be performed in a different order, or not performed, depending on specific applications. It is noted that the method 1300 may not be the only way to operate the buck converter circuit 800. Accordingly, it is understood that additional processes can be provided before, during, or after method 1300, and that some of these additional processes may be briefly described herein.

At 1302, the method 1300 includes performing a DC-to-DC voltage conversion in a voltage regulator circuit coupled to a dynamic load, e.g., using the buck converter circuit 800, in accordance with some implementations of the present disclosure. In some implementations, the input voltage can be about 10 to about 100 times larger than the output voltage.

At 1304, the method 1300 includes providing output current (e.g., Iₒᵤₜ in the voltage loop 805) from a multiphase current source (e.g., IL1 from the first current loop 840 and IL2 from the current loop 845) in accordance with some implementations of the present disclosure.

At 1306, the method 1300 includes varying a pulse frequency (e.g., a frequency of the trigger pulse 832, generated in the control stage 110d) in response to a change in load current, (e.g., I_{Load}) in accordance with some implementations of the present disclosure. Increasing the pulse frequency can decrease the delay time before the output current matches the load current.

At 1308, the method 1300 includes varying a pulse width (e.g., a width of the trigger pulse 832 generated in the control stage 110d) to provide adaptive on-time control, in accordance with some implementations of the present disclosure. Varying the pulse width corresponds to changing, e.g., expanding, the on-time Tₒₙ.

At 1310, the method 1300 includes matching the output current Iₒᵤₜ to the load current I_{Load} with minimal time delay, in accordance with some implementations of the present disclosure.

At 1312, the method 1300 includes delivering an output voltage (e.g., Vₒᵤₜ) with no undershoot, in accordance with some implementations of the present disclosure.

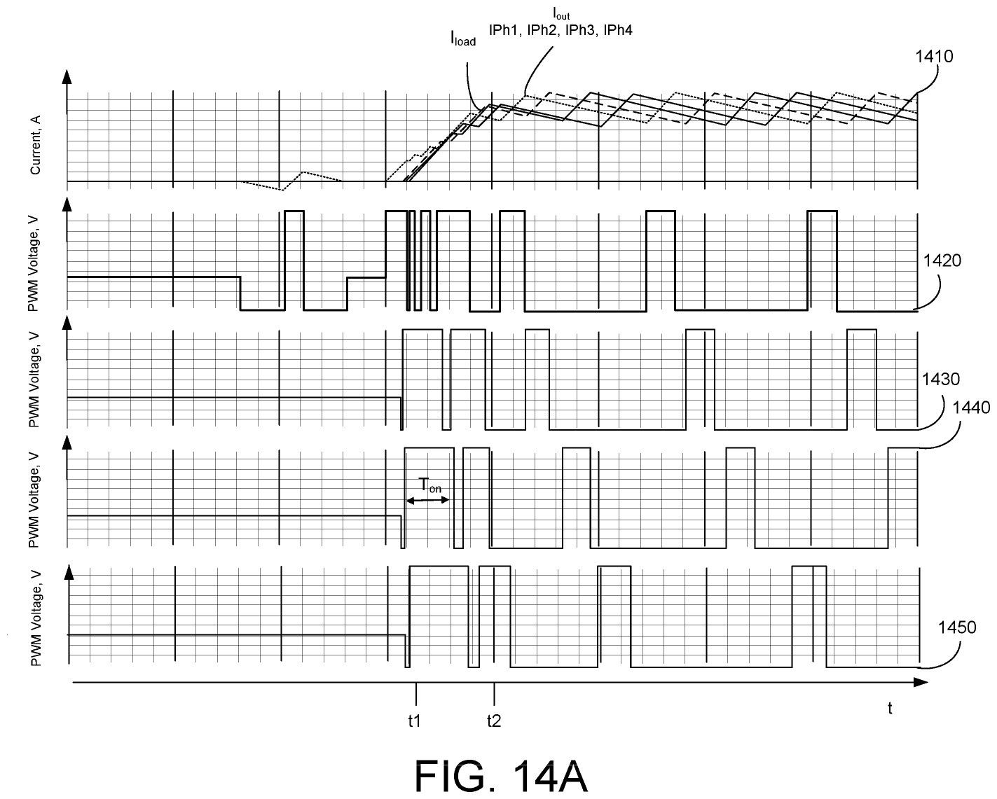

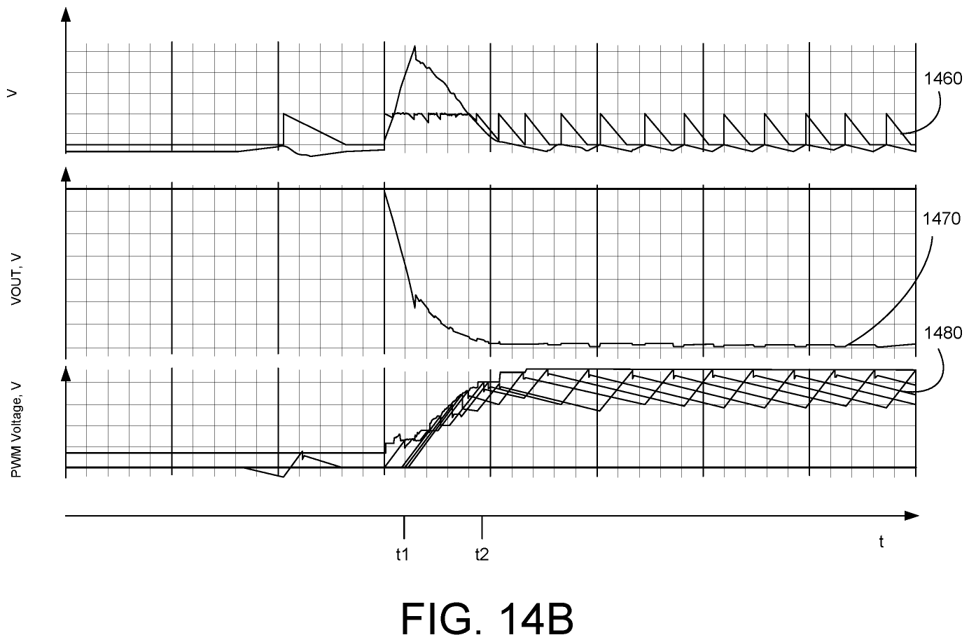

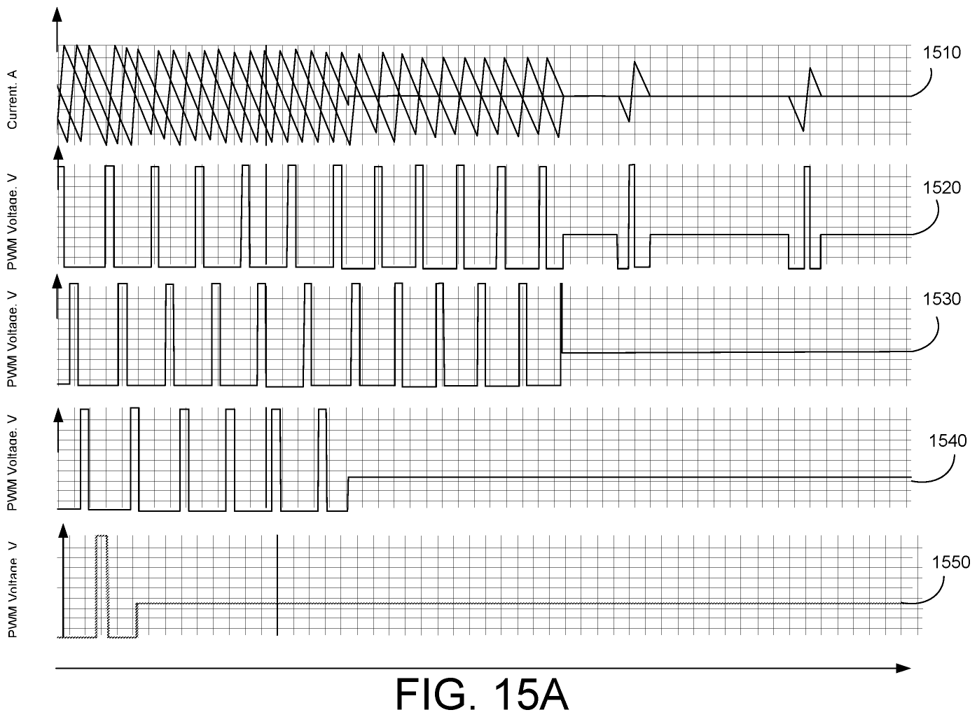

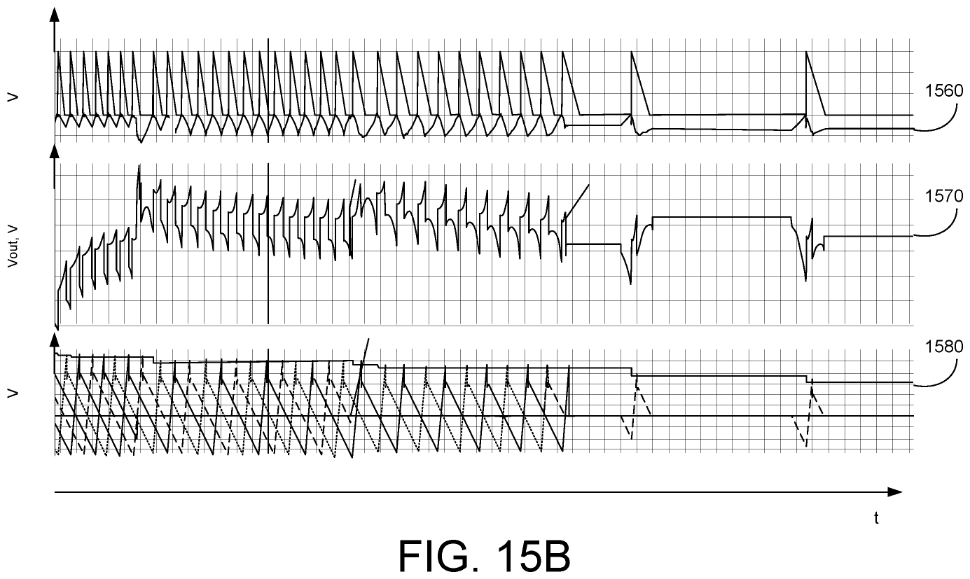

FIGS. 14A-14B and 15A-15B illustrate simulation results produced by a Simulation of Piecewise Linear Systems (SIMPLIS) model simulation of at least the buck converter circuit 800, according to some implementations of the present disclosure. FIGS. 14A and 14B show simulation results corresponding to the buck converter circuit 800 with extended on-time and current share error correction performance. More specifically, FIGS. 14A and 14B show a series of plots 1410 through 1470 in response to a load current step-up of 144 Amps in a four-phase system, for an input voltage of 5 V and an output voltage of 0.9 V. In this simulation, the output capacitance is 1.5 mF and the droop resistance is 1.1 mΩ. However, the output voltage signal remains stable when the output capacitance is less than 1 mF. The dynamic load current 1410 suddenly begins increasing at timestep t1 and by timestep t2, the buck converter circuit 800 has adjusted so that the output current Iₒᵤₜ has risen in increasing steps to substantially match the load current I_{load}, and the voltage error 1460 has dissipated.

The top panel of FIG. 14A shows the relationship between phase currents IPh1, IPh2, IPh3, IPh4, the load current, and the output current. The pulse wave modulation (PWM) pulse plots 1420, 1430, 1440, and 1450 show high-frequency voltage pulses during a two-second dynamic response duration between t1 and t2, returning to a frequency of one pulse per timestep thereafter. The PWM pulse plots further show variable pulse widths (Tₒₙ) in response to changes in the dynamic load current thus providing adaptable on-time control. Phase currents have increased rapidly and reached steady state by timestep t2 with minimal error. This happens by both rapidly extending PWM on-time and increasing operating frequencies 1510, 1520, 1530, and 1540 in a stable dynamic and static current share performance. When the load current stabilizes at timestep t2, PWM pulse widths again become uniform. The phase1 PWM signal has different operating frequency and Tₒₙ response (1440) to other phases because its current IPh1 is lagging other parallel phases at the initial load step. The current share loop increases phase1 frequency more rapidly until it catches up with other phase currents in the system. Plot 1480 shows Tₒₙ ramps in response to dynamic loading with a minimum ramp at IPh information and peak ramp at Vid+I2 current reference. As the output current rises, the output voltage 1470 drops from 0.9 V to 0.76 V for a 1.1mR*I_{Load} droop response with zero undershoot response showing another advantage of this system.

FIGS. 15A and 15B show output voltage disturbance and current share correction response to phase shedding. FIGS. 15A and 15B indicate excellent current share, good stability, and minimal output disturbance during a phase adding process from four-phase operation down to one-phase operation.

As described above, various implementations of a multi-phase buck inverter circuit with COT control can improve performance by reducing the response time to changes in a dynamic load, providing variable on-time in the control signal, and balancing currents by adding current share loops.

It will be understood that, in the foregoing description, when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, top, bottom, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

Some implementations may be implemented using various semiconductor processing and/or packaging techniques. Some implementations may be implemented using various types of semiconductor device processing techniques associated with semiconductor substrates including, but not limited to, for example, silicon (Si), silicon carbide (SiC), gallium arsenide (GaAs), gallium nitride (GaN), and/or so forth.

While certain features of the described implementations have been illustrated as described herein, many modifications, substitutions, changes, and equivalents will now occur to those skilled in the art. For instance, features illustrated with respect to one implementation can, where appropriate, also be included in other implementations. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A circuit, comprising:
a multiphase current source, including:
a first current loop configured to drive a first inductor with a first drive signal at a first switching frequency;
a second current loop configured to drive a second inductor with a second drive signal at a second switching frequency; and
a voltage loop comprising a constant on-time (COT) control stage configured to provide a control signal with a leading edge modulation based on voltage error and a trailing edge modulation based on current share error.

2. The circuit of claim 1, wherein the first drive signal and the second drive signal are pulse width modulation (PWM) drive signals, the first drive signal is out of phase with the second drive signal.

3. The circuit of claim 2, wherein an output voltage signal is configured to have a zero undershoot response when the multiphase current source is coupled to a dynamic load.

4. The circuit of claim 1, wherein the COT control stage includes an integrator.

5. The circuit of claim 1, wherein the COT control stage includes a trigger ramp signal.

6. The circuit of claim 1, wherein the COT control stage is configured to provide trigger pulses that are out of phase with one another.

7. The circuit of claim 1, wherein at least one of the first current loop and the second current loop of the multiphase current source is implemented as a masterless current share loop configured to provide a trailing edge current error correction.

8. The circuit of claim 7, wherein a gain of the masterless current share loop is dynamically adjustable based on an error signal level.

9. The circuit of claim 7, wherein a gain of the masterless current share loop is part of a Tₒₙ ramp.

10. The circuit of claim 9, wherein a gain of the masterless current share loop is adjustable by changing a height of the Tₒₙ ramp.

11. The circuit of claim 1, configured as a buck voltage regulator circuit in which an output voltage is less than an input voltage.

12. The circuit of claim 11, wherein the input voltage is in a range of about 5 V to about 21 V and the output voltage is in a range of about 0.2 V to about 3.3 V.

13. The circuit of claim 1, configured as a boost voltage regulator circuit in which an output voltage is greater than an input voltage.

14. The circuit of claim 1, wherein a footprint of the circuit is less than about 25 mm².

15. A method of regulating a voltage, the method comprising:
performing a DC-to-DC voltage conversion in a multiphase current source coupled to a dynamic load;
outputting a current from the multiphase current source;
varying a pulse frequency in response to a change in a load current of the dynamic load;
varying a pulse width in response to the change in the load current, to provide adaptive on-time control;
increasing the output current to match the load current; and
producing an output voltage signal having zero undershoot.

16. The method of claim 15, wherein the response to the change in the load current includes supplying the output current in increasing steps.

17. The method of claim 15, wherein providing the output current includes use of a masterless current balance procedure.

18. The method of claim 15, wherein the method is compatible with analog, digital, and hybrid implementations.

19. A system, comprising:
a power delivery circuit configured to deliver power to a dynamic load, the power delivery circuit including:
a voltage regulator having an input voltage, an output voltage, and an output capacitance; and
a constant on-time (COT) control stage configured to provide variable on-time in response to a change in the dynamic load.

20. The system of claim 19 wherein the voltage regulator is configured to provide an output voltage signal with zero undershoot.

21. The system of claim 20, wherein the output voltage signal remains stable when the output capacitance is less than 1 mF.

22. The system of claim 19, further comprising a multiphase current source system configured with adjustable current share gain.
